(19) United States
(12) Patent Application Publication
(10) Pub. No.: US 2011/0069500 A1
(43) Pub. Date: Mar. 24, 2011

(54) Heat Dissipation Module For Bulb Type LED Lamp

(76) Inventors: George Anthony Meyer, IV, San Jose, CA (US); Chien-Hung Sun, Zhongli City (TW); Chieh-Ping Chen, Zhongli City (TW)

(21) Appl. No.: 12/563,494

(22) Filed: Sep. 21, 2009

(51) Int. Cl. F21V 29/00

(52) U.S. Cl. 362/373

(57) ABSTRACT

The heat dissipation module includes a heat dissipation assembly and a heat conducting element. The heat dissipation assembly includes a cylinder provided with a central hole. The central hole tapers off inwards to form two corresponding inclined surfaces. The heat conducting element, which is accommodated in the central hole, has a heat-absorbing section and two heat-releasing sections extending from the heat-absorbing section and being in contact with the inclined surfaces.

### BACKGROUND OF THE INVENTION

1. Technical Field

The invention generally relates to LED lamps, particularly to heat dissipation modules for LED lamps.

2. Related Art

Light Emitting Diodes (LED) have various advantages such as low energy consumption, low heat, long durability, small size and fast response. Thus the LEDs have been replacing conventional lamps. The LEDs must be placed on a circuit board to form an LED module. Additionally, the LED module is usually associated with a heat sink to prevent from overheating.

However, this structure will invite a problem of uneven heat conduction. Because the LED module thermally contacts a part of the heat sink, only that part of the heat sink can provide higher thermal conductivity. Thus the heat from the LED module can not be rapidly dissipated. The interior of the heat sink will receive uneven thermal stress. The heat sink may be damaged by the thermal deformation. Additionally, the durability of the LED module may be shortened due to the insufficient thermal conductivity.

### SUMMARY OF THE INVENTION

An object of the invention is to rapidly and evenly dissipate the heat from the LED module.

To accomplish the abovementioned object, the invention provides a heat dissipation module, which comprises a heat dissipation assembly and a heat conducting element. The heat dissipation assembly includes a cylinder provided with a central hole. The central hole tapers off inwards to form two corresponding inclined surfaces. The heat conducting element, which is accommodated in the central hole, has a heat-absorbing section and two heat-releasing sections extending from the heat-absorbing section and being in contact with the inclined surfaces.

The heat conducting element has a heat-absorbing section and two heat-releasing sections, so directly thermal contact can be formed between the heat conducting element and LED or heat dissipation assembly. The heat dissipation efficiency can be improved.

Additionally, walls of the central hole have the same thickness, so the heat from the LED can be rapidly and effectively released by the walls.

### BRIEF DESCRIPTION OF THE INVENTION

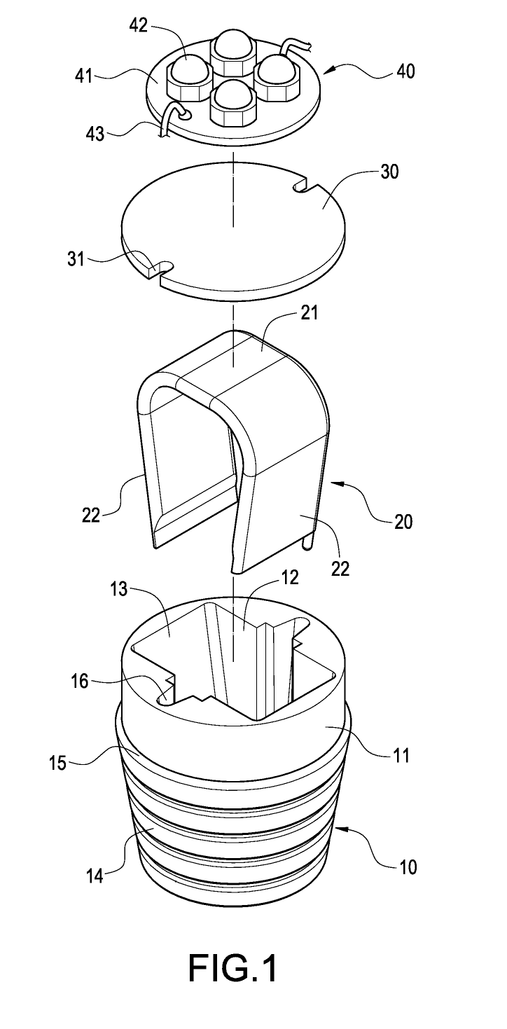

FIG. 1 is an exploded view of the invention;

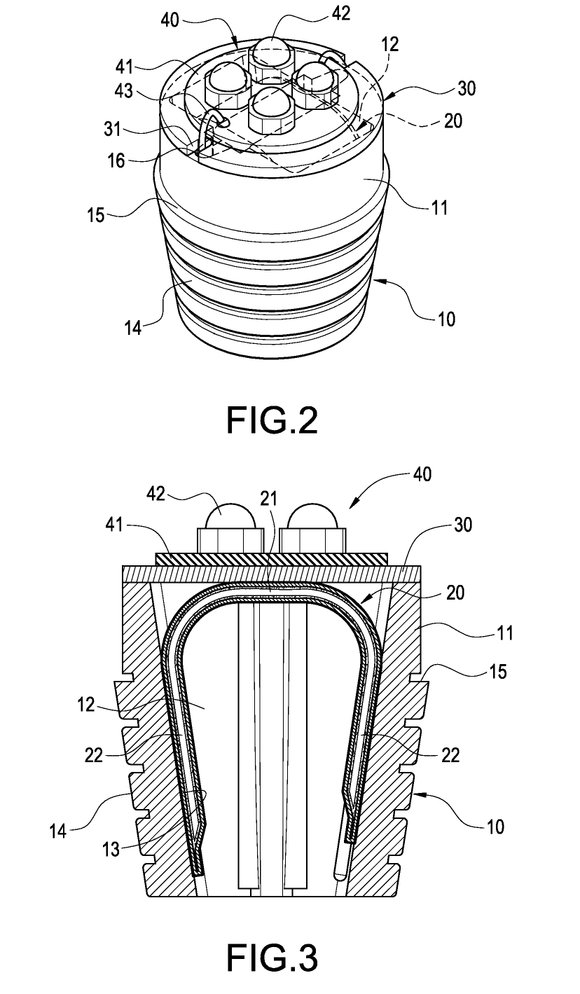

FIG. 2 is a perspective view of the invention;

FIG. 3 is a sectional view of the invention;

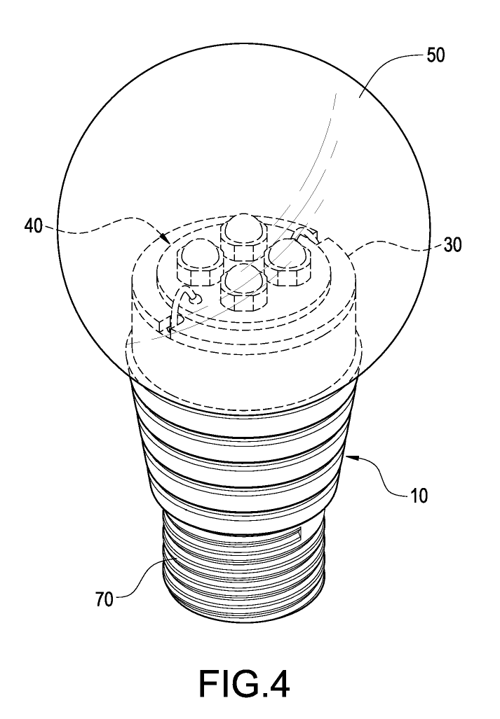

FIG. 4 is a perspective view of the invention in use;

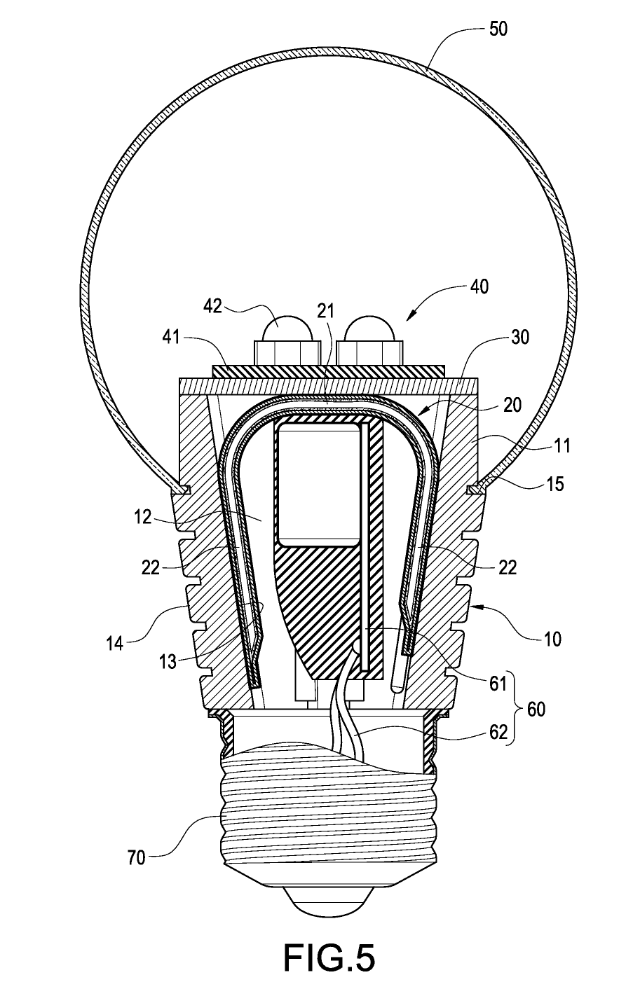

FIG. 5 is a sectional view of the invention in use; and

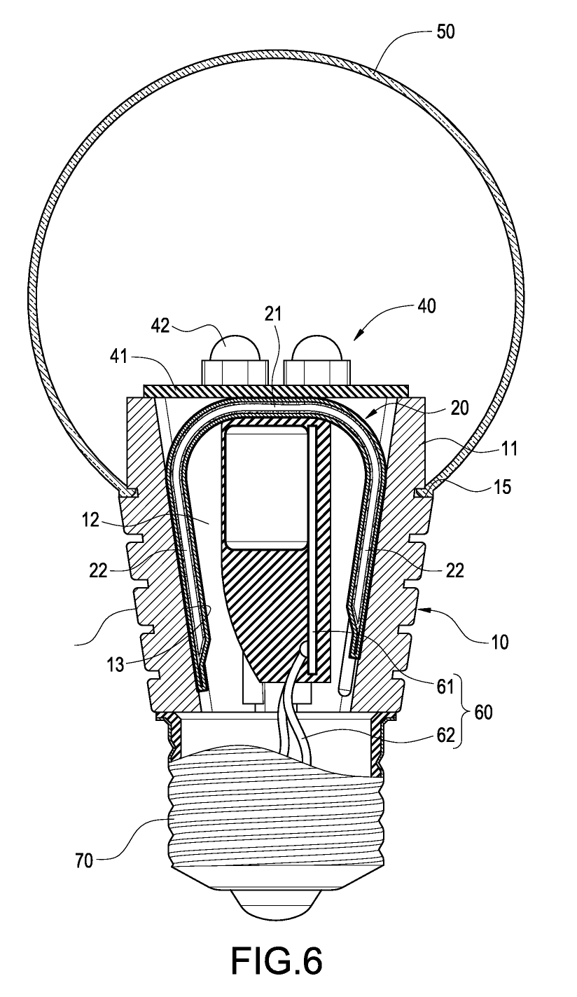

FIG. 6 is a sectional view of another embodiment of the invention.

### DETAILED DESCRIPTION OF THE INVENTION

Referring to FIG. 1, the heat dissipation module for a bulb type LED lamp of the invention is essentially composed of a heat dissipation assembly 10 and a sheet-shaped heat conducting element 20. The heat dissipation module can be connected to an LED module 40 by a mounting plate 30. By this arrangement, the heat from the LED module 40 can be conducted to the heat conducting element 20 through the mounting plate 30, and then the heat can be dissipated to the outside. Besides, as shown in FIG. 5, the LED lamp further includes a transparent cover 50, a transformer 60 for supplying power to the LED module 40 and a base 70 connected to the bottom of the heat dissipation assembly 10.

Referring to FIGS. 1-3, the hear dissipation assembly 10, which is made by the aluminum die casting process, includes a cylinder 11. A central hole 12 is provided in the center of the cylinder 10. The central hole 12 tapers off from its opening to bottom to form two corresponding inclined surfaces 13. Thus a tapered space is formed in the cylinder 11. In particular, as can be seen in FIG. 3, thickness of the walls having the inclined surfaces 13 is uniform for providing an even effect of heat dissipation.

In this embodiment, a plurality of ribs 14 are provided on the outside of the cylinder 11 for adding surface area and increasing heat dissipation efficiency. Additionally, the outside of the cylinder 11 near the top is further provided with an annular groove 15 for being mounted by the transparent cover 50. The bottom of the cylinder 11 connects to the base 70 by screwing or soldering connection as shown in FIG. 4. Thus the base 70 can be fixed in a lamp socket on a wall or ceiling.

The heat conducting element 20 is completely accommodated in the central hole 12. The heat conducting element 20 includes a heat-absorbing section 21 and two heat-releasing sections 22 separately extending from the heat-absorbing section 21. Both size and shape of the two heat-releasing sections correspond to the inclined surfaces 13 of the heat dissipation assembly 10 so that the heat-releasing sections 22 can contact the inclined surfaces 13. In the shown embodiment, the heat conducting element 20 is an inverted-U shaped vapor chamber. Because a vapor chamber has a bigger interior space for accommodating more working fluid to make phase change, it can transfer more heat in a unit time. Besides, the vapor chamber having two heat-releasing sections can release heat simultaneously, and all heat contacting areas between the heat conducting element 20 and a heat generating source or the heat dissipation assembly 10 are directly planar contact, so its effect of heat transfer is much better than a heat pipe.

The heat-absorbing section 21 of the heat conducting element 20 is attached to the mounting plate 30 to form thermal contact. In this embodiment, the mounting plate 30 is of a shape of disk for matching the shape of the heat dissipation assembly 10, and two indents 31 are provided at the edge of the mounting plate 30 for being passed through by wires 43.

The LED module 40 includes a substrate 41, a plurality of LEDs 42 mounted on the substrate 41 and the two wires 43 extending from the substrate 41. The LED module 40 planarly connects to the mounting plate 30 to form thermal contact. The wires 43 of the LED module 40 pass through the indents 31 and then extend downwards. An inner surface of the heat dissipation assembly 10 is provided with two troughs 16 for accommodating the wires 43. The wires 43 electrically connect to a circuit board 61 in the transformer 60. In addition, the other wires 62 in the transformer 60 separately connect to two electrodes of the base 70 for obtaining power via the base 70. By the arrangement of the troughs 16, the wires 43 do not retard the thermal contact between the heat dissipation assembly 10 and heat conducting element 20.

Referring to FIG. 5, the heat-absorbing section 21 of the heat conducting element 20 can also make thermal contact with the transformer 60. In other word, the heat from the transformer 60 can be transferred to the heat dissipation assembly 10 by the heat conducting element 20.

FIG. 6 shows another preferred embodiment of the invention. This embodiment retrenches the mounting plate 30 of the abovementioned embodiment. In this embodiment, the substrate 41 of the LED module 40 is enlarged enough to be placed on the opening of the central hole 12 of the heat dissipation assembly 10. The substrate 41 is directly attached to the heat-absorbing section 21 of the heat conducting element 20 to form thermal contact.

It will be appreciated by persons skilled in the art that the above embodiments have been described by way of example only and not in any limitative sense, and that various alterations and modifications are possible without departure from the scope of the invention as defined by the appended claims.

What is claimed is:

1. A heat dissipation module for a bulb type light emitting diode (LED) lamp comprising:
a heat dissipation assembly comprising a cylinder, a central hole being provided in the cylinder, the central hole tapering off inwards to form two corresponding inclined surfaces; and
a heat conducting element, being of a sheet shape, accommodated in the central hole, and having a heat-absorbing section and two heat-releasing sections extending from the heat-absorbing section and being in contact with the inclined surfaces.

2. The heat dissipation module for a bulb type LED lamp of claim 1, wherein thickness of walls having the inclined surfaces is uniform.

3. The heat dissipation module for a bulb type LED lamp of claim 1, wherein the heat dissipation assembly is made by an aluminum die casting process.

4. The heat dissipation module for a bulb type LED lamp of claim 1, wherein a plurality of ribs are provided on the cylinder.

5. The heat dissipation module for a bulb type LED lamp of claim 1, wherein the heat conducting element is a vapor chamber.

6. The heat dissipation module for a bulb type LED lamp of claim 1, wherein the LED lamp further comprises a transformer accommodated in the heat dissipation assembly and being in contact with the heat conducting element.
